(19) United States
(12) Patent Application Publication
(10) Pub. No.: US 2021/0270309 A1
(43) Pub. Date: Sep. 2, 2021

(54) WASHER ASSEMBLY FOR ANTENNA MOUNTS

(71) Applicant: CommScope Technologies LLC, Hickory, NC (US)

(72) Inventors: Michel Andrew Dembinski, Dallas, TX (US); John W. Orem, Allen, TX (US)

(21) Appl. No.: 17/257,388

(22) PCT Filed: Jul. 2, 2019
(86) PCT No.: PCT/US2019/040224

§ 371 Date: Dec. 31, 2020

Related U.S. Application Data
(60) Provisional application No. 62/694,320, filed on Jul. 5, 2018.

(51) Int. Cl. F16B 43/00; H01Q 1/12

(52) U.S. Cl. CPC F16B 43/001; H01Q 1/1207

(57) ABSTRACT

The present disclosure describes an antenna mount assembly. The antenna mount assembly may comprise an antenna, a mounting bracket, and a washer assembly residing between the antenna and the mounting bracket. A washer assembly is also described. The washer assembly may comprise two outer gaskets and an inner washer residing between and coupled to the two outer gaskets.

### STATEMENT OF PRIORITY

The present application claims priority from and the benefit of U.S. Provisional Application No. 62/694,320, filed Jul. 5, 2018, the disclosure of which is hereby incorporated by reference herein in its entirety.

### FIELD OF THE INVENTION

The invention relates to an antenna mount assembly, and more particularly, to a washer assembly for use with an antenna mounting bracket.

### BACKGROUND OF THE INVENTION

Most base station antennas are secured to a mounting structure (e.g., an antenna tower) by an external mounting bracket. Typically, this external mounting bracket is connected to the core of the antenna by a fastener. Currently, in the middle of the interface between the external mounting bracket and the antenna is an aluminum washer with pre-applied gaskets. However, using these aluminum washers creates an intermittent metal/metal interface (between a ring on the washer and the antenna) which may increase the potential for unwanted passive intermodulation (PIM). Reduced costs in manufacturing are also desired.

### SUMMARY OF THE INVENTION

A first aspect of the present invention is directed to an antenna mount assembly. The antenna mount assembly may comprise an antenna, a mounting bracket, and a washer assembly residing between the antenna and the mounting bracket. The washer assembly may comprise two outer gaskets and an inner washer residing between and coupled to the two outer gaskets. Each outer gasket may be formed of a polymeric material and the washer may be formed of a non-metallic material.

Another aspect of the present invention is directed to a washer assembly. The washer assembly may comprise two outer gaskets and inner washer residing between and coupled to the two outer gaskets. Each outer gasket may be formed of a polymeric material and the inner washer may be formed of a non-metallic material.

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim and/or file any new claim accordingly, including the right to be able to amend any originally filed claim to depend from and/or incorporate any feature of any other claim or claims although not originally claimed in that manner. These and other objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1 is a front perspective view of an antenna mount assembly according to embodiments of the present invention.

FIG. 2 is an enlarged view of the washer assembly for the antenna mount assembly of FIG. 1.

FIG. 3A is d front perspective view of a washer assembly according to embodiments of the present invention.

FIG. 3B is a side view of the washer assembly of FIG. 3A.

FIG. 4A is a side section view of a washer assembly according to further embodiments of the present invention.

FIG. 4B is a top section view along section line “A” of the washer assembly of FIG. 4A.

FIG. 5 is a side section view of a washer assembly according to further embodiments of the present invention.

FIG. 6A is a side section view of a washer assembly according to further embodiments of the present invention.

FIG. 6B is a top section view along section line “B” of the washer assembly of FIG. 6A.

FIG. 7 is a side section view of a washer assembly according to further embodiments of the present invention.

FIG. 8A is a side section view of a washer assembly according to further embodiments of the present invention.

FIG. 8B is a top section view along section line “C” of the washer assembly of FIG. 8A.

FIG. 9 is a side section view of a washer assembly according to further embodiments of the present invention.

FIG. 10 is a front perspective view of a washer assembly according to further embodiments of the present invention.

### DETAILED DESCRIPTION OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

The present invention now will be described more fully hereinafter with reference to the accompanying drawings, in which illustrative embodiments of the invention are shown.

In the figures, certain layers, components or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

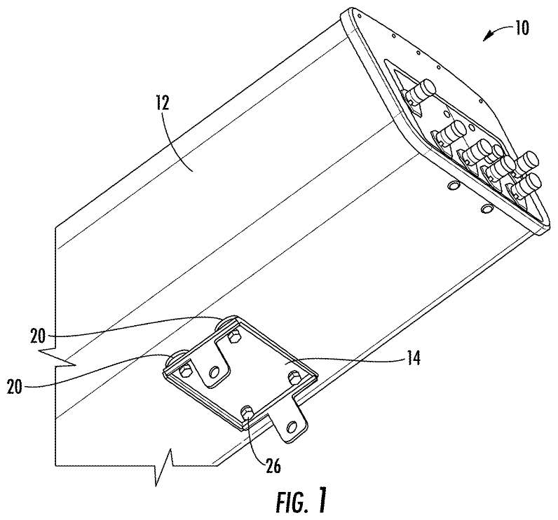

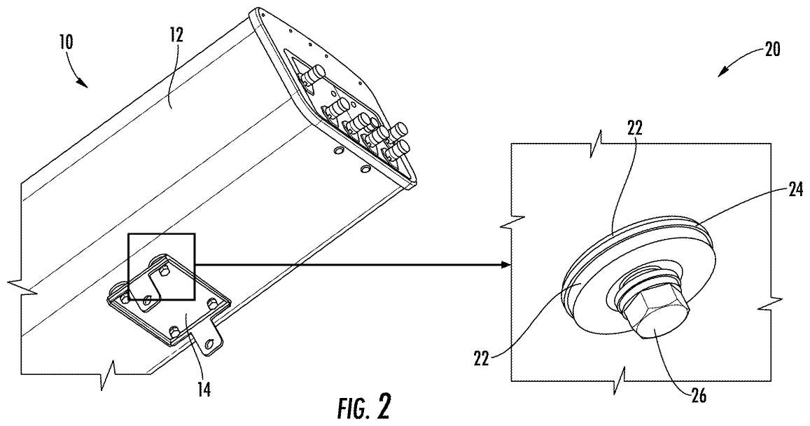

Referring now to the figures, an antenna mount assembly 10 according to some embodiments of the present invention is illustrated in FIG. 1 and FIG. 2. The antenna mount assembly 10 may comprise an antenna 12, a mounting bracket 14, and multiple washer assemblies 20. The washer assembly 20 may reside between the antenna 12 and the mounting bracket 14. FIG. 2 is an enlarged view of the antenna mount assembly 10 showing one of the washer assemblies 20.

The mounting bracket 14 may be connected to the core of the antenna 12 by way of a fastener 26. Any fastener 26 may be used to connect the mounting bracket 14 to the antenna 12. Typically, the fastener 26 is a bolt. As will be discussed in further detail below, when placed between the antenna 12 and the mounting bracket 14, the washer assembly 20 can provide a path for the clamp load created by the fastener 26. Placing the washer assembly 20 between the antenna 12 and the mounting bracket 14 may also provide a water-tight seal with the antenna 12 which can help protect the internal electronics of the antenna 12 from the environment, for example, rain, snow, moisture, etc.

As shown in FIGS. 3A and 3B, the washer assembly 20 may comprise two outer gaskets 22 and an inner washer 24. The inner washer 24 may reside between and be coupled to the two outer gaskets 22. In some embodiments, the inner washer 24 may be attached to the outer gaskets 22 by an adhesive.

The washer assembly 20 can vary in size depending on the size of the antenna mount assembly 10, i.e., the size of the antenna 12 and/or mounting bracket 14. The shape of the washer assembly 20 can also vary, for example, the washer assembly 20 can be circular, square, elliptical, etc. Typically, the washer assembly 20 is circular and may have a diameter (D) of about 35 mm to about 45 mm. In some embodiments, the washer assembly 20 may have a thickness (T) of about 8 mm to about 18 mm.

In some embodiments, each outer gasket 22 may be formed of a polymeric material. For example, each outer gasket 22 may be formed of a thermoset elastomer or a thermoplastic elastomer. In some embodiments, the polymeric material forming the outer gaskets 22 may comprise rubber, polypropylene, or a combination thereof, or the like.

In some embodiments, the inner washer 24 may be formed of a non-metallic material. The non-metallic material forming the inner washer 24 may comprise a polymeric material. For example, in some embodiments, the polymeric material forming the inner washer 24 may comprise fiberglass and/or acrylonitrile/styrene/acrylate (ASA), or the like.

As mentioned above, when placed between the antenna 12 and the mounting bracket 14, the washer assembly 20 can provide a path for the clamp load created by the fastener 26. A clamp load is created when a torque is applied to the fastener 26. As the fastener 26 is torqued, a tension load develops in the fastener 26 and an equal compressive load develops in the parts being fastened, i.e., the antenna 12 and the mounting bracket 14. The washer assembly 20 can provide this external tension load with a path other than through fastener 26, thereby reducing the fatigue loading on the fastener 26.

In some embodiments, the inner washer 24 may be formed of a polymeric material that is stiffer than the polymeric material forming the outer gaskets 22. A stiffer polymeric material can provide a more stable load path for the clamp load created by the fastener 26. For example, if the mounting bracket 14 were attached directly to the antenna 12 without a washer assembly 20, part of the clamp load created by the fastener 26 would be applied directed to the antenna 12. Over time the clamp load could cause damage to the radome of the antenna 12. Using the washer assembly 20 can allow the clamp load on the antenna 12 to be reduced, thereby helping protect the antenna 12 from possible damage. In some embodiments, the washer assembly 20 may be configured to withstand a clamp load of 9000 N to about 12000 N.

In addition to helping provide a path for the clamp load created by the fastener 26, the washer assembly 20 may also provide a seal with the antenna 12. In some embodiments, the outer gaskets 22 may be formed of a more pliable polymeric material than the polymeric material forming the inner washer 24. The more pliable polymeric material can allow the inner washer 24 to create a water-tight seal with the antenna 12 when the clamp load is applied. The seal created between the washer assembly 20 and the antenna 12 can help protect the internal electronics of the antenna 12 from the environment, e.g., protecting from rain, snow, moisture, etc.

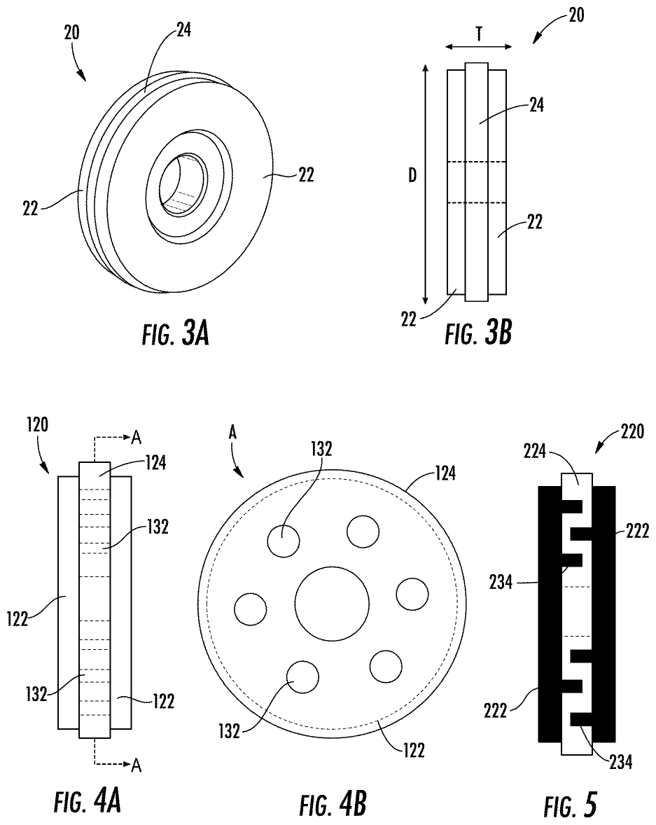

Referring now to FIGS. 4-10, various geometric modifications may be made to the outer gaskets 22 and/or inner washer 24 of the washer assembly 20. These geometric modifications may be made to adapt the sealing and compressive properties of the molded gaskets 22 to the different types of antennas 12 and/or mounting brackets 14 that may be used with the antenna mount assembly 10. These modifications may also improve the integrity between the gaskets 22 and the inner washer 24. The outer gaskets 22 and inner washer 24 may also be formed by various manufacturing methods known in the art, including, but not limited to, over-molding, injection molding, compression molding, and the like.

For example, as shown in FIGS. 4A and 4B, in some embodiments, the two outer gaskets 122 of the washer assembly 120 may be over-molded over the inner washer 124. In some embodiments, the inner washer 124 may comprise through holes 132 which become filled by the over-molded outer gaskets 122 (FIG. 4A). This arrangement may help to anchor the gaskets 122 onto the inner washer 124. FIG. 4B shows a top section view of the washer assembly 120 along section line “A”.

Referring to FIG. 5, in some embodiments, the inner washer 224 of the washer assembly 220 may comprise cavities 234 which become filled by the over-molded outer gaskets 222. Use of over-molding when manufacturing the washer assembly 120, 220 can eliminate the need for an adhesive to attach the outer gaskets 122, 222 to the inner washer 124, 224, thereby reducing manufacturing costs.

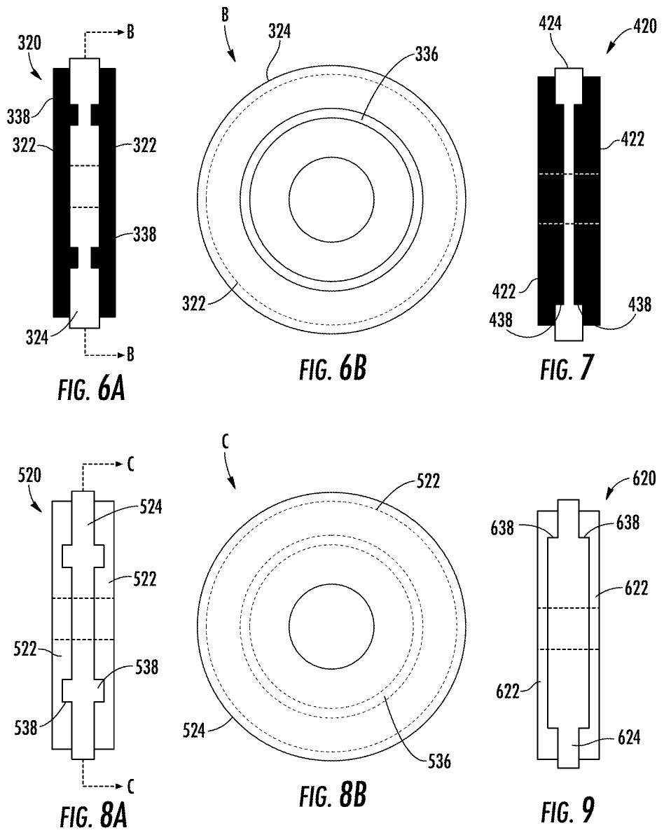

As illustrated in FIG. 6A and FIG. 6B, in some embodiments, the inner washer 324 of the washer assembly 320 may comprise at least one circumferential groove 336 on each side of the inner washer 324. The two outer gaskets 322 may each comprise at least one circumferential protrusion 338 dimensioned to securely fit within one of the grooves 336 of the inner washer 324. As shown in FIG. 7, in some embodiments, the circumferential protrusions 438 of the outer gaskets 422 of the washer assembly 420 may vary in size and diameter.

Similarly, as illustrated in FIGS. 8A and 8B, in some embodiments, the two outer gaskets 522 of washer assembly 520 each may comprise at least one circumferential groove 536 and the inner washer 524 may comprise at least one circumferential protrusion 38 on each side of the inner washer 524. The protrusions 538 may be dimensioned to securely fit within the grooves 536 of the outer gaskets 522. Again, including protrusions 538 dimensioned to securely fit within grooves 536 can eliminate the need for an adhesive to attach the outer gaskets 522 to the inner washer 524.

Similar to the embodiment illustrated in FIG. 7, in some embodiments, the circumferential protrusions 638 of the inner washer 624 of the washer assembly 620 may also vary in size and diameter (FIG. 9).

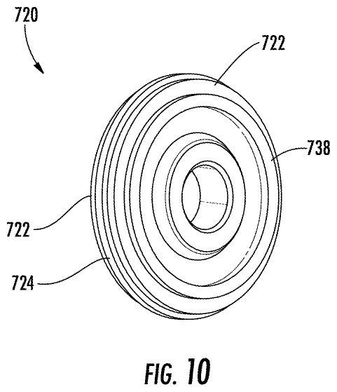

As shown in FIG. 10, in some embodiments, the outer gaskets 722 of the washer assembly 720 may have at least one protrusion 738 on an exterior side of each gasket 722, i.e., the side of the gasket 722 that is not in contact with the inner washer 724. Including at least one protrusion 738 on the exterior sides of the outer gaskets 722 may assist in providing a water-tight seal between the washer assembly 720 and the antenna 12.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

1. An antenna mount assembly, comprising:
an antenna;
a mounting bracket; and
a washer assembly residing between the antenna and the mounting bracket, the washer assembly comprising:
two outer gaskets, each outer gasket formed of a polymeric material; and
an inner washer formed of a non-metallic material, the inner washer residing between and coupled to the two outer gaskets.

2. The antenna mount assembly of claim 1, wherein the non-metallic material forming the inner washer comprises a polymeric material.

3. The antenna mount assembly of claim 2, wherein the polymeric material forming the inner washer comprises fiberglass and/or acrylonitrile/styrene/acrylate (ASA).

4. The antenna mount assembly of claim 1, wherein the two outer gaskets comprise rubber and/or polypropylene.

5. The antenna mount assembly of claim 1, wherein the two outer gaskets are over-molded over the inner washer.

6. The antenna mount assembly of claim 5, wherein the inner washer comprises through holes filled by the over-molded outer gaskets.

7. The antenna mount assembly of claim 1, wherein the inner washer comprises at least one circumferential groove on each side of the inner washer and the two outer gaskets each comprise at least one circumferential protrusion dimensioned to securely fit within one of the grooves of the inner washer.

8. The antenna mount assembly of claim 1, wherein the two outer gaskets each comprise at least one circumferential grove and the inner washer comprises at least one circumferential protrusion on each side of the inner washer dimensioned to securely fit within the grooves of the outer gaskets.

9. The antenna mount assembly of claim 1, wherein the washer assembly is configured to withstand a clamp load of 9000 N to about 12000 N.

10. The antenna mount assembly of claim 1, wherein the washer assembly has a diameter of about 35 mm to about 45 mm.

11. The antenna mount assembly of claim 1, wherein the washer assembly has a thickness of about 8 mm to about 18 mm.

12. (canceled)

13. A washer assembly, comprising:
two outer gaskets, each outer gasket formed of a polymeric material; and
an inner washer formed of a non-metallic material, the inner washer residing between and coupled to the two outer gaskets.

14. The washer assembly of claim 13, in combination with an antenna and a mounting bracket, wherein the washer assembly provides a seal between the antenna and the mounting bracket.

15. The washer assembly of claim 13, wherein the non-metallic material forming the inner washer comprises a polymeric material.

16. The washer assembly of claim 15, wherein the polymeric material forming the inner washer comprises fiberglass and/or acrylonitrile/styrene/acrylate (ASA).

17. The washer assembly of claim 13, wherein the two outer gaskets comprise rubber and/or polypropylene.

18. The washer assembly of claim 13, wherein the inner washer comprises at least one circumferential groove on each side of the inner washer and the two outer gaskets each comprise at least one circumferential protrusion dimensioned to securely fit within one of the grooves of the inner washer.

19. The washer assembly of claim 13, wherein the two outer gaskets each comprise at least one circumferential grove and the inner washer comprises at least one circumferential protrusion on each side of the inner washer dimensioned to securely fit within the grooves of the outer gaskets.

20. The washer assembly of claim 13, wherein the two outer gaskets are over-molded over the inner washer.

21. The washer assembly of claim 20, wherein the inner washer comprises through holes filled by the over-molded outer gaskets.

22.-24. (canceled)
